(19) United States
(12) Patent Application Publication
(10) Pub. No.: US 2021/0279882 A1
(43) Pub. Date: Sep. 9, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kazutoshi IKEDA, Kanagawa (JP)

(73) Assignee: FUJIFILM BUSINESS INNOVATION CORP., Tokyo (JP)

(21) Appl. No.: 16/923,550

(22) Filed: Jul. 8, 2020

(30) Foreign Application Priority Data
Mar. 5, 2020 (JP) 2020-038262

(51) Int. Cl. G06T 7/12; G06F 3/0354; G06F 3/0362; G06F 3/0485; G06F 3/0484; G06T 3/40; G06T 11/20

(52) U.S. Cl. CPC G06T 7/12; G06F 3/03541; G06F 3/0362; G06F 3/04855; G06T 2207/20212; G06T 3/40; G06T 11/203; G06T 2200/24; G06F 3/04845

(57) ABSTRACT

An information processing apparatus includes a processor configured to acquire an original image and multiple outline coordinate pairs of an outline of a region to be cut out from the original image and to control display in an image display area to superimpose an image of the outline onto a portion of the original image so that pixels that correspond to the multiple outline coordinate pairs consecutively appear in a central region of the image display area in clockwise or counterclockwise order.

### CROSS-REFERENCE TO RELATED APPLICATIONS

This application is based on and claims priority under 35 USC 119 from Japanese Patent Application No. 2020-038262 filed Mar. 5, 2020.

### BACKGROUND

### (i) Technical Field

The present disclosure relates to an information processing apparatus and a non-transitory computer readable medium.

### (ii) Related Art

Image processing is performed to extract a desired target region from an original image. After the extraction, the target region is inserted into another image, or different image processing is applied to the target region and the region other than the target region in the original image. For example, after a merchandise image region (target region) is extracted from an original image that has captured one or more pieces of merchandise, various kinds of image processing are performed. Specifically, different color adjustments are applied to the merchandise image region and to the background region (region other than the target region) surrounding the merchandise image region, or the background region is replaced with a different image.

To extract a target region from an original image, a mask image, which includes a cutout region that is specified so as to have the same position and shape as the target region, is used. A mask image has a cutout region and the region other than the cutout region, and examples of a mask image include an image in which the cutout region and the other region are differently colored and an image in which the outline of a cutout region is attached to the original image.

Japanese Unexamined Patent Application Publication No. 2-101456 discloses a method of producing cutout mask data for extracting or eliminating a desired area to be processed in an original image. In the method, a plurality of small unit areas are designated in a reduced original image displayed on an image display, and unit area images, each of which corresponds to the image of one of the plurality of small unit areas, are displayed without reduction. Then, a vertex, which is to form the outline of the area to be processed, is specified in each unit area image displayed without reduction, and thus the cutout mask data is produced.

### SUMMARY

Some programs, which have a function of cutting out an image of a desired region from an original image, superimpose onto the original image a mask image, which is an image representing a region to be cut out, determine a cutout region by correcting the mask image, and perform various processes, such as cutout and color correction of the cutout region in the original image. If the outline of the cutout region is displaced from a desired position, the target region cannot accurately be extracted from the original image, and thus an operator needs to precisely check whether the outline of the cutout region is placed at the desired position.

The number of pixels in the cutout region in the mask image typically exceeds the number of pixels that can be displayed by an image display device. Thus, if the whole of the cutout region is displayed, it is difficult to check the details of the cutout region. Further, during a precise check of the position of the outline of the cutout region, if an enlarged image of a portion of the outline of the cutout region to be checked is displayed, the operator needs to move the image to check another portion of the outline that is not displayed on a display screen. For example, the operator needs to use a component such as a mouse to operate vertical and horizontal scroll bars displayed on the display screen, and this operation involves considerable work.

Aspects of non-limiting embodiments of the present disclosure relate to providing a configuration that enables an operator to check the outline of a cutout region on a display screen of an image display device in a simpler manner than by using vertical and horizontal movement operation in a case where the operator checks the outline of the cutout region having more pixels than can be displayed by the image display device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire an original image and a plurality of outline coordinate pairs of an outline of a region to be cut out from the original image and to control display in an image display area to superimpose an image of the outline onto a portion of the original image so that pixels that correspond to the plurality of outline coordinate pairs consecutively appear in a central region of the image display area in clockwise or counterclockwise order.

### BRIEF DESCRIPTION OF THE DRAWINGS

An exemplary embodiment of the present disclosure will be described in detail based on the following figures, wherein:

FIG. 1 is a block diagram depicting an example of a configuration of an information processing apparatus;

FIG. 2 is an illustration depicting an example of an original image;

FIG. 3 is an illustration depicting an example of a mask image without the original image;

FIG. 4 is an illustration depicting an example of a mask image with the original image;

FIG. 5 is an illustration to describe generation of a piece of outline information;

FIG. 6 is an illustration depicting an example of a piece of outline information;

FIG. 7 is an illustration to describe consecutive movements of a check region of a mask image;

FIG. 8 is an illustration to describe consecutive movements of a check region of a mask image;

FIG. 9 is an illustration depicting an example of an image of a portion of a mask image;

FIG. 10 is an illustration depicting an example of a display screen to check an edge by mouse wheel operation;

FIG. 11 is a flowchart depicting a flow of image display control based on mouse wheel operation;

FIG. 12 is an illustration depicting an example of a display screen to check an edge by using an automatic preview function;

FIG. 13 is a flowchart depicting a flow of image display control based on an automatic preview function;

FIG. 14 is an illustration to describe a checking process of the outlines of a plurality of cutout regions;

FIG. 15 is an illustration to describe image display control of an intricate outline of a cutout region; and

FIG. 16 is an illustration to describe different image display control of an intricate outline of a cutout region.

### DETAILED DESCRIPTION

Hereinafter, an exemplary embodiment according to the present disclosure will be described in detail with reference to the accompanying drawings. The configuration described below is an example for illustration and can appropriately be modified in accordance with a condition such as a specification of an apparatus. If a plurality of examples, modifications, and the like are included in the following description, it is assumed from the beginning that each feature described below is appropriately combined with other features. The same or similar elements are denoted by the same reference numerals or symbols in all the figures and are not repeatedly described.

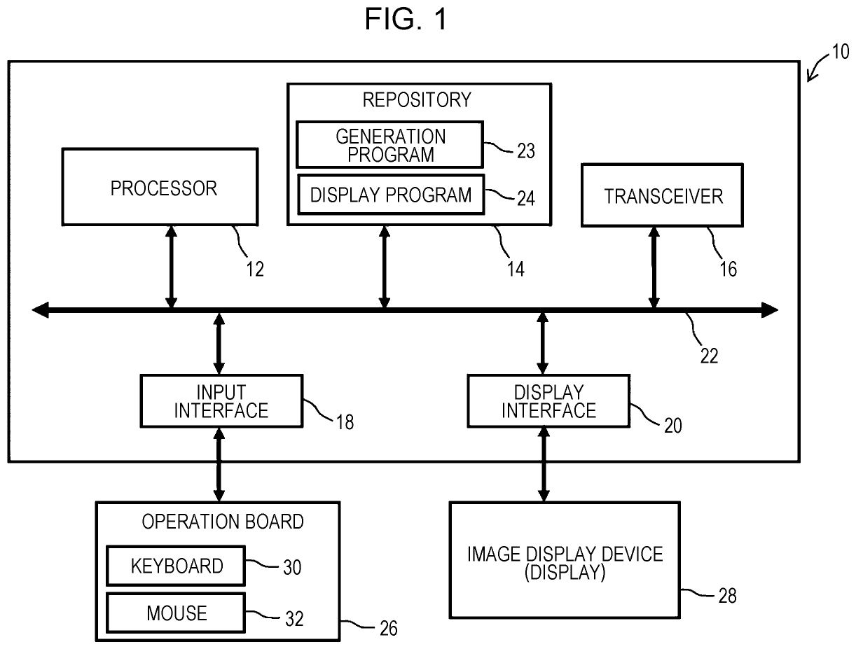

FIG. 1 is a block diagram depicting an example of a configuration of an information processing apparatus 10. The information processing apparatus 10 is constituted by a personal computer (PC). A keyboard 30 and a mouse 32, which constitute an operation board 26 for operating the information processing apparatus 10, and a display 28 are connected to the information processing apparatus 10. A portable terminal, such as a tablet or a smartphone, may constitute the information processing apparatus 10 in other examples. In such a case, the information processing apparatus 10 may include the operation board 26 and the display 28, and a touch panel may constitute the operation board 26 and the display 28.

The information processing apparatus 10 in the present exemplary embodiment includes a processor 12, a repository 14, a transceiver 16, an input interface 18, and a display interface 20, which are connected to each other by using a bus 22.

The processor 12 includes a central processing unit (CPU) and executes information processing in accordance with a program installed into the information processing apparatus 10. The processor 12 may be referred to as a computer. The repository 14 is constituted by a read-only memory (ROM), a random-access memory (RAM), a flash memory, a hard disk, and the like and stores programs executed by the processor 12 and various kinds of data. The transceiver 16 is constituted by, for example, a network card and connects to a network (not shown), such as a local area network (LAN) or the Internet, via wireless or wired communication to communicate with other apparatuses. The input interface 18 is a device to receive a signal from the operation board 26 and transmit operation information to the processor 12. The display interface 20 is, for example, a graphic card and outputs a video signal to the display (also referred to as an image display device) 28 in accordance with instructions from the processor 12.

The programs include a generation program 23 and a display program 24. The generation program 23 and the display program 24, which are to be installed into the information processing apparatus 10, may be provided not only via a network, such as the Internet, but also in a stored form of a computer readable recording medium, such as an optical disc or a universal-serial-bus (USB) memory.

The information processing apparatus 10 receives an image (hereinafter, referred to as an original image) via a network, such as the Internet, or by using a computer readable recording medium, such as an optical disc or a USB memory. The information processing apparatus 10 operates based on the generation program 23 to generate a mask image from the original image and operates based on the display program 24 to display a check screen for the mask image on the display 28. The mask image indicates a region corresponding to an image to be cut out from the original image. In many image editing programs, the mask image is superimposed onto the original image, and an operator edits the mask image by enlarging or reducing the region corresponding to an image to be cut out. After the mask image has been edited, the processing to generate a cutout image from the original image is performed by using the information regarding the region corresponding to an image to be cut out.

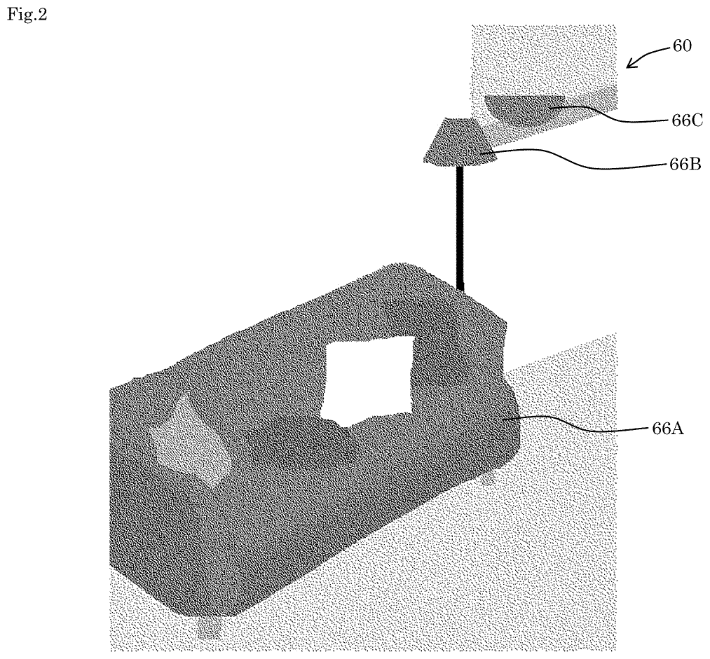

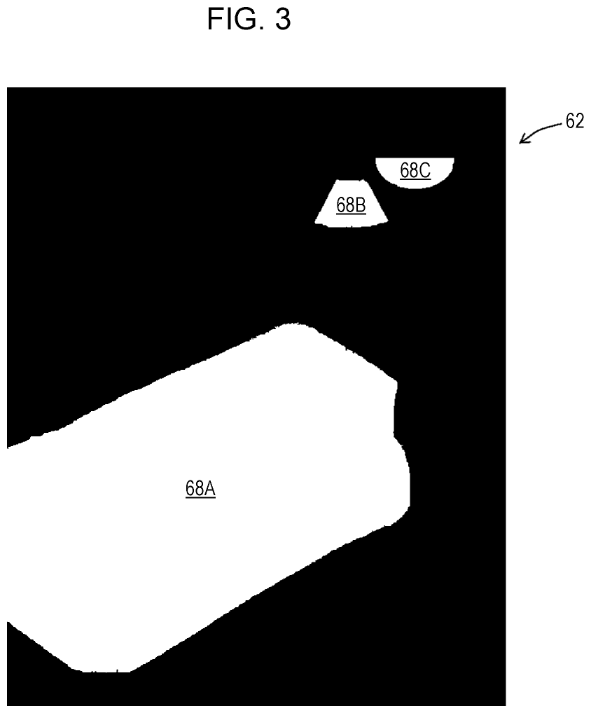

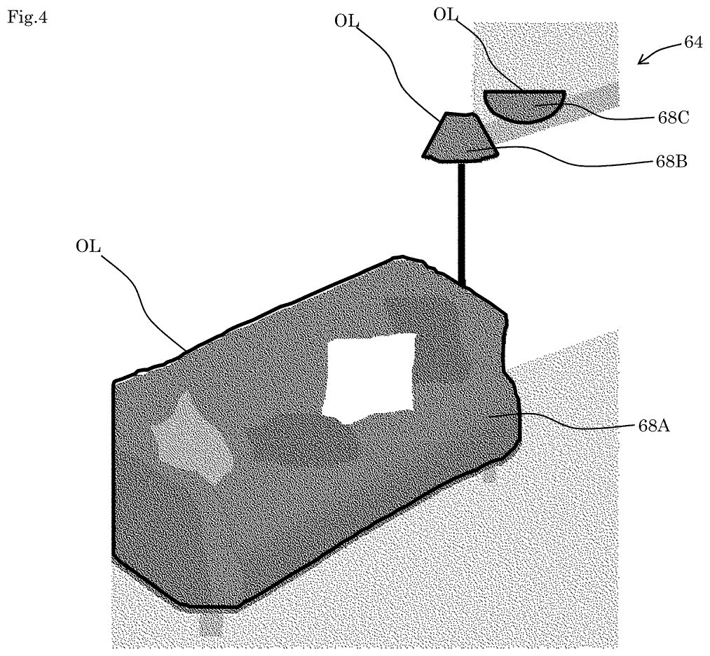

FIG. 2 is an example of an original image 60, and FIG. 3 is a mask image 62, which corresponds to the original image 60 in FIG. 2 and is generated in a process that is separate from the production process of the original image 60. FIG. 4 is a mask image 64 in a different form, which corresponds to the original image 60 in FIG. 2, and the mask image 64 is formed by superimposing onto the original image 60 the outline of a region to be cut out.

Each of the mask images 62 and 64 represents desired target regions 66A, 66B, and 66C (refer to FIG. 2) in the original image 60 and is an image containing region-specifying information to cut out the target regions 66A, 66B, and 66C and insert the target regions into another image or to divide the original image 60 into the target regions 66A, 66B, and 66C and the region other than the target regions and apply different image processing accordingly. In the example of FIG. 2, the target region 66A represents a sofa, the target region 66B represents a lampshade, and the target region 66C represents a decorative object placed on a shelf.

The processor 12 of the information processing apparatus 10 operates based on the generation program 23 and analyzes characteristics of the original image 60, such as the difference between the color of the target region and the color of the region other than the target region. The processor 12 extracts one or more cutout regions in accordance with the analysis and generates the mask images 62 and 64 in accordance with the coordinate information of the outlines of the one or more cutout regions. The mask images 62 and 64, which are generated, are formed so that cutout regions 68A, 68B, and 68C are identifiable as regions to be cut out. The cutout regions 68A, 68B, and 68C are specified so as to be placed in the same positions and to have the same shape as the target regions 66A, 66B, and 66C, respectively. In the mask image 62 in FIG. 3, the cutout regions 68A, 68B, and 68C and the region other than the cutout regions are differently colored. In the mask image 64 in FIG. 4, the outlines OL of the cutout regions 68A, 68B, and 68C are attached to the original image 60.

It is to be noted that the target regions 66A, 66B, and 66C do not necessarily match the cutout regions 68A, 68B, and 68C. Whereas the target regions 66A, 66B, and 66C are regions that the operator desires to extract, the cutout regions 68A, 68B, and 68C are regions obtained from the analysis of the original image 60 performed by the information processing apparatus 10 (presumptive regions). Accordingly, it is possible that the cutout regions 68A, 68B, and 68C do not match the target regions 66A, 66B, and 66C. In other words, the outlines OL of the cutout regions 68A, 68B, and 68C may be displaced from the positions desirable for the operator.

Since a cutout region is cut out from an original image at the outline OL of the cutout region, a target region cannot be cut out from the original image as desired if the outline OL of the cutout region is displaced from the desired line. Thus, the operator needs to precisely check whether the boundary of the cutout region matches the desired line. Accordingly, the information processing apparatus 10 executes the display program 24 and thus provides a check screen for the mask image. The check screen for the mask image will be described in detail below.

In the following description, the term “mask image” with no reference numeral is used to indicate the mask image 64 such as is depicted in FIG. 4, in which the outline OL is superimposed onto the original image 60. The mask image 64 is not limited to an image in which the outline OL is attached to the original image 60 and may be an image in which the outline OL is attached to the original image 60 after certain image processing is applied.

The repository 14 of the information processing apparatus 10 stores the mask image 64, which is generated, and outline coordinate pairs, which are coordinate pairs of a plurality of outline pixels that form the outline OL of each of the cutout regions 68A, 68B, and 68C in the mask image 64. In the above description, it is assumed that the information processing apparatus 10 forms the mask image 64, but it may be assumed that another apparatus forms the mask image 64 and the mask image 64 is input into the information processing apparatus 10 and stored in the repository 14. In such a case, the plurality of outline coordinate pairs of the cutout regions 68A, 68B, and 68C in the mask image 64 may be input into the information processing apparatus 10 along with the mask image 64, or may alternatively be extracted by the information processing apparatus 10, which analyzes the mask image 64.

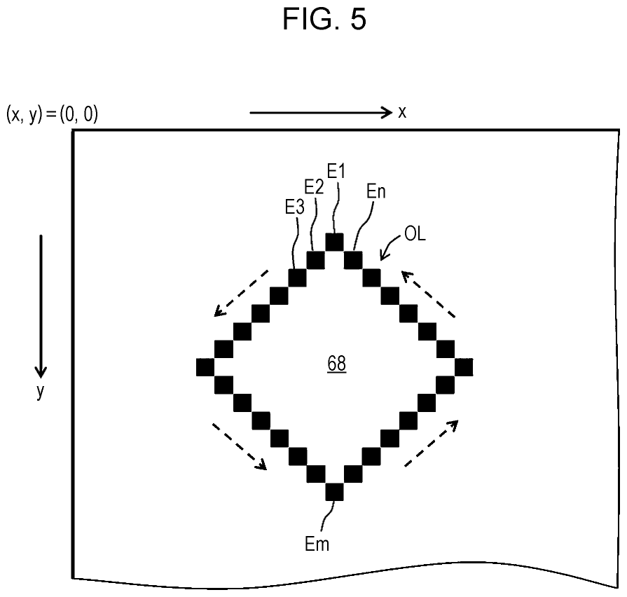

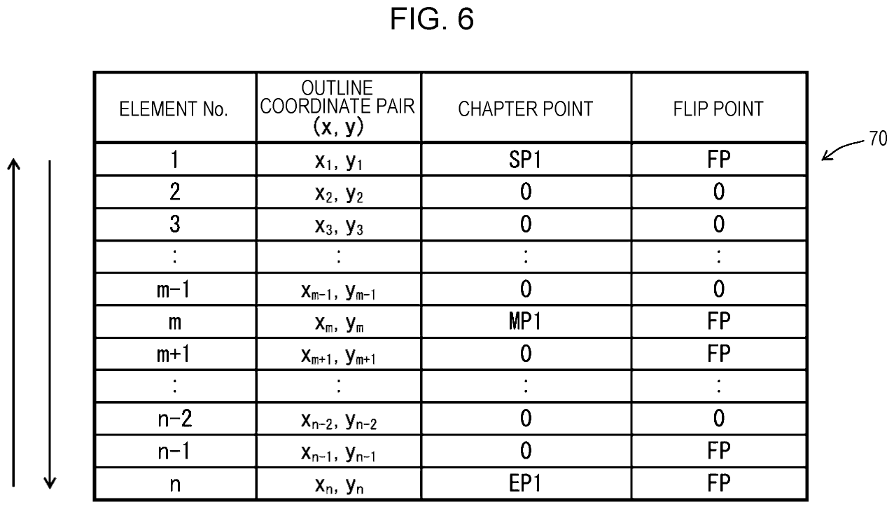

The processor 12 operates based on the display program 24 and generates a piece of outline information that describes information regarding pixels forming the outline OL. Generation of a piece of outline information will be described below. The processor 12 reads the plurality of outline coordinate pairs of the cutout regions 68A, 68B, and 68C from the repository 14 and generates a piece of outline information for each of the cutout regions 68A, 68B, and 68C. FIG. 5 is an illustration to describe generation of a piece of outline information, and FIG. 6 is an illustration depicting an example of a piece of outline information 70.

FIG. 5 depicts a plurality of outline pixels of a cutout region 68, which corresponds to any one of the cutout regions 68A, 68B, and 68C, on the xy plane. The processor 12 first searches for an outline pixel that is to be the first element (element No. 1) of the piece of outline information 70. Starting from (x, y)=(0, 0), the value of x is increased to the maximum (furthest to the right), and after the value of y is increased by 1, the value of x is increased similarly from (x, y)=(0, 1). The outline pixel that is found first during the repetition of such a scan is designated as the first element of the piece of outline information 70. In the example of FIG. 5, the outline pixel E1 is the first element of the piece of outline information (element No. 1), and the outline coordinate pair (x₁, y₁) of the outline pixel E1 is stored in the piece of outline information 70.

Then, the processor 12 designates as the second element (element No. 2) an outline pixel adjacent to the outline pixel designated as the first element. In the example of FIG. 5, two outline pixels E2 and En are adjacent to the outline pixel E1, which is designated as the first element. In this example, the outline pixel E2 is designated as the second element (element No. 2), and the outline coordinate pair (x₂, y₂) of the outline pixel E2 is stored in the piece of outline information 70.

Then, similarly to the above procedure, the processor 12 designates as the third element (element No. 3) an outline pixel adjacent to the outline pixel designated as the second element. At this time, the third element is searched for among adjacent outline pixels excluding outline pixels already stored in the piece of outline information 70. In the example of FIG. 5, an outline pixel E3 adjacent to the outline pixel E2, which is designated as the second element, is designated as the third element (element No. 3), and the outline coordinate pair (x₃, y₃) of the outline pixel E3 is stored in the piece of outline information 70.

Repeating the search operation described above enables a plurality of outline coordinate pairs of the cutout region 68 to be stored in the piece of outline information 70 in counterclockwise order (the order indicated by dashed arrows depicted in FIG. 5) in the outline OL of the cutout region 68. In the example of FIG. 5, an outline pixel Em is designated as the m-th element (element No. m), and an outline element En is designated as the n-th element (element No. n) in the end. Whether an outline pixel is the final outline pixel can be determined based on whether the outline pixel E1, which is the element No. 1, is included in adjacent outline pixels.

The method of generating the piece of outline information 70 described above is an illustrative example, and other methods may be adopted to generate the piece of outline information 70. In the above description, the plurality of outline coordinate pairs are stored in the piece of outline information 70 in counterclockwise order in the outline OL of the cutout region 68 but may be stored in the piece of outline information 70 in clockwise order in the outline OL of the cutout region 68. The processor 12 stores in the repository 14 the piece of outline information 70 generated for each cutout region 68. The piece of outline information 70 depicted in FIG. 6 includes elements referred to as a “chapter point” and a “flip point”, which will be described below.

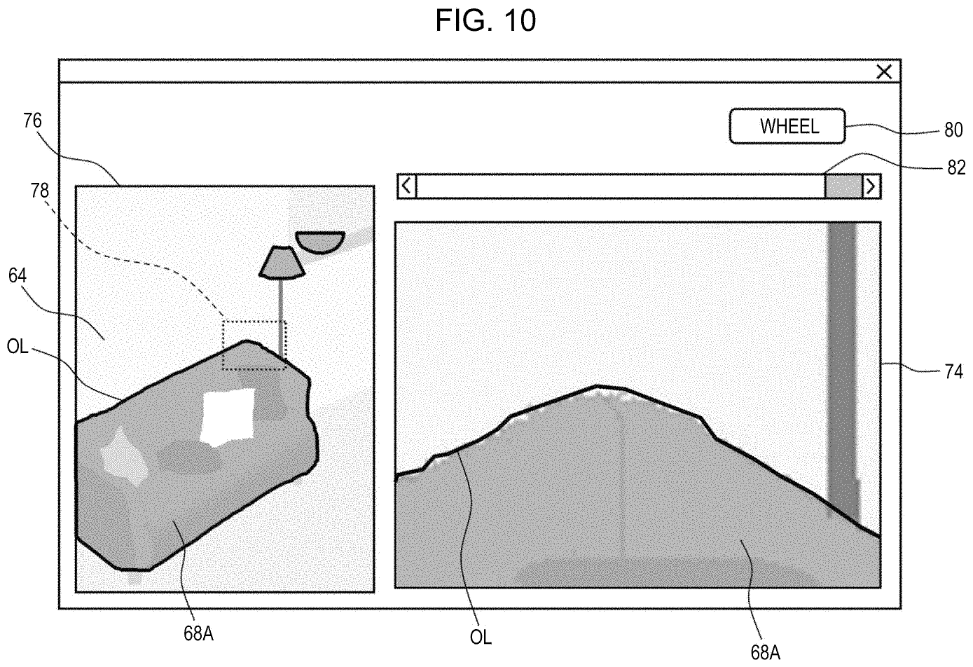

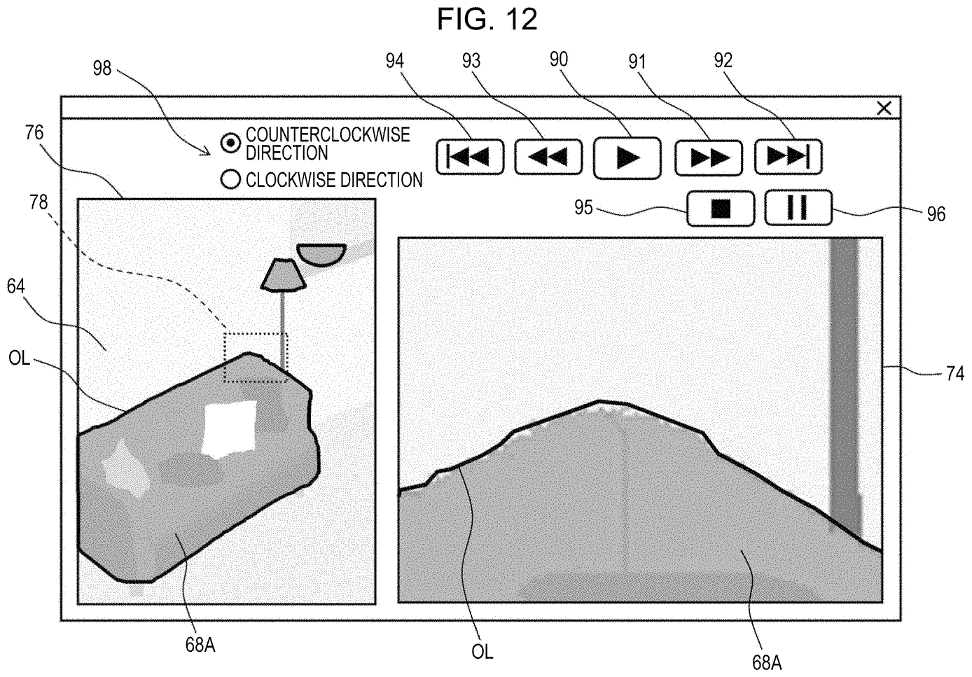

Next, the processor 12 operates based on the display program 24 and thus displays a check screen for the mask image 64 by using the piece of outline information 70. As a representative example, the check screen for the mask image 64 is presented in a mode in which a check region is moved based on the mouse wheel operation by the operator (FIG. 10) or in a mode in which a check region is automatically moved (FIG. 12, an automatic preview function). First, the basic operation of the processor 12 and a check region, which are the same for each mode, will be described.

When displaying the check screen for the mask image 64 on the display 28, the processor 12 reads (acquires) the mask image 64 and the piece of outline information 70 (a plurality of outline coordinate pairs of the cutout regions 68) from the repository 14. Then, the processor 12 consecutively reads the outline coordinate pairs or elements that are stored in counterclockwise or clockwise order in the piece of outline information 70 and controls display to cause a portion of the mask image 64 to be displayed in an image display area of the display 28 without dropping any pixel so that the outline pixels that correspond to the plurality of the outline coordinate pairs consecutively appear at the center of the image display area of the display 28 in counterclockwise or clockwise order. The portion of the mask image 64 corresponds to the check region.

The number of pixels in the cutout region 68 in the mask image 64 typically exceeds the number of pixels that can be displayed by the display 28. Thus, if the whole of the cutout region 68 is to be displayed on the display 28, some pixels in the cutout region 68 are dropped, and the outline OL of the cutout region 68 is only partially displayed. Consequently, the operator is not able to precisely check whether the boundary of the cutout region 68 matches the desired line. Thus, in the present exemplary embodiment, the portion of the mask image 64 is displayed without dropping any pixel as described above. In other words, the pixels located in the check region of the mask image 64 are displayed by the display 28 as they are without dropping any pixel.

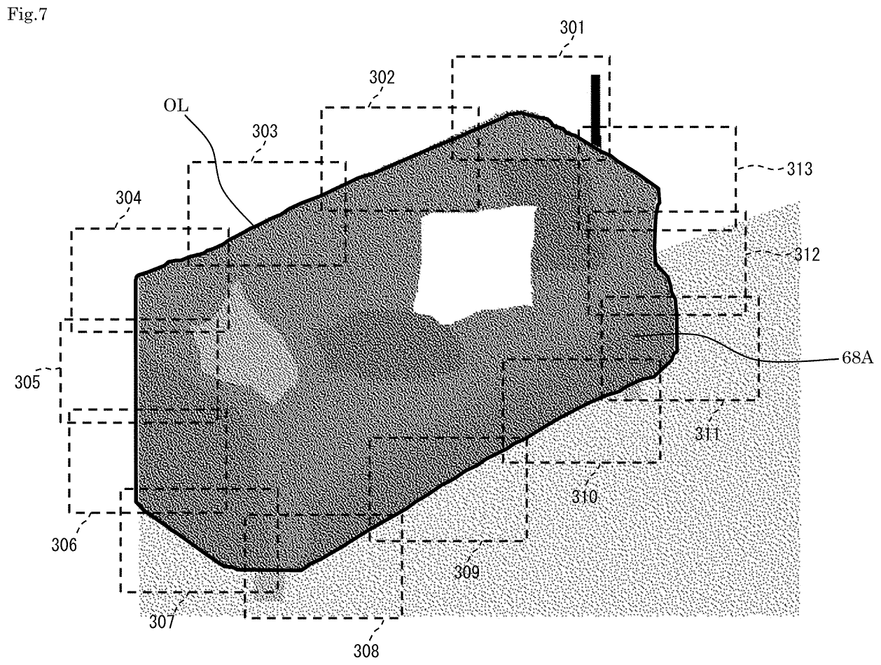

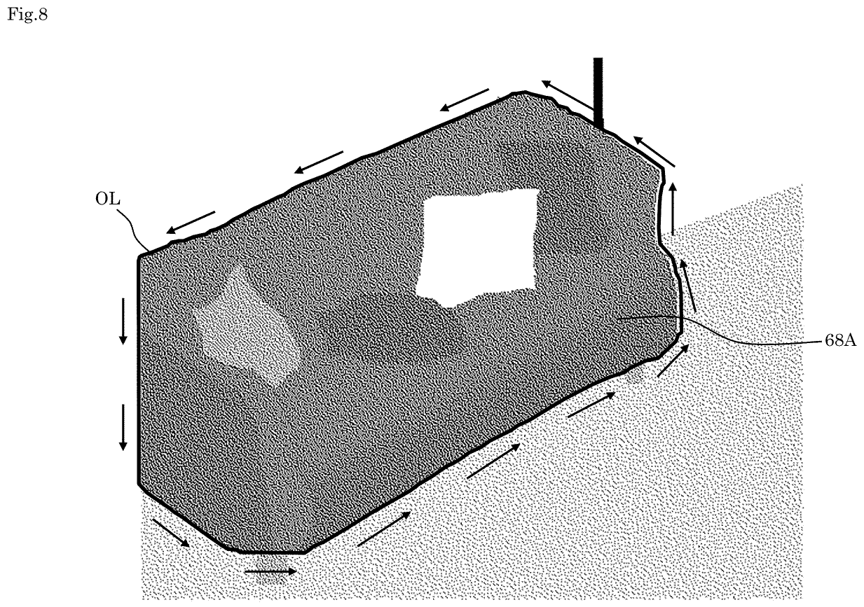

FIGS. 7 and 8 are illustrations to describe consecutive movements of the check region of the mask image. FIGS. 7 and 8 depict the cutout region 68A, which corresponds to a sofa, in the mask image depicted in FIG. 4. The processor 12 reads the outline coordinate pair (x₁, y₁) of the outline pixel corresponding to the element No. 1 from the piece of outline information 70 and causes a check region 301, whose center is located at the outline coordinate pair (x₁, y₁), to be displayed in the image display area of the display 28. Next, the processor 12 reads the outline coordinate pair (x₂, y₂) of the outline pixel corresponding to the element No. 2 from the piece of outline information 70 and causes a check region (not shown), whose center is located at the outline coordinate pair (x₂, y₂), to be displayed in the image display area of the display 28. In this way, the processor 12 consecutively reads the outline coordinate pairs from the piece of outline information 70 and displays check regions in the image display area in succession. Consequently, the check region to be displayed moves in the direction indicated by arrows depicted in FIG. 8 (counterclockwise direction), and the check regions along the closed loop of the outline OL of the cutout region 68A are consecutively displayed in the image display area. FIG. 7 depicts check regions 301, 302, 303, . . . , and 313, but many check regions to be displayed in the image display area are also present between the check regions 301, 302, 303, . . . , and 313 depicted in FIG. 7. The control described above causes the check regions 301, 302, 303, . . . , and 313 and the check regions present between the check regions 301, 302, 303, . . . , and 313 (not shown) to be displayed in the image display area in counterclockwise order.

The processor 12 may read elements of the piece of outline information 70 in descending order (for example, may read elements in descending order of the element number, starting from the element No. n) and may cause the check regions, whose centers are located at the outline coordinate pairs of the elements, to be consecutively displayed in the image display area of the display 28. In such a case, the check region to be displayed moves along the outline OL of the cutout region 68A in clockwise direction.

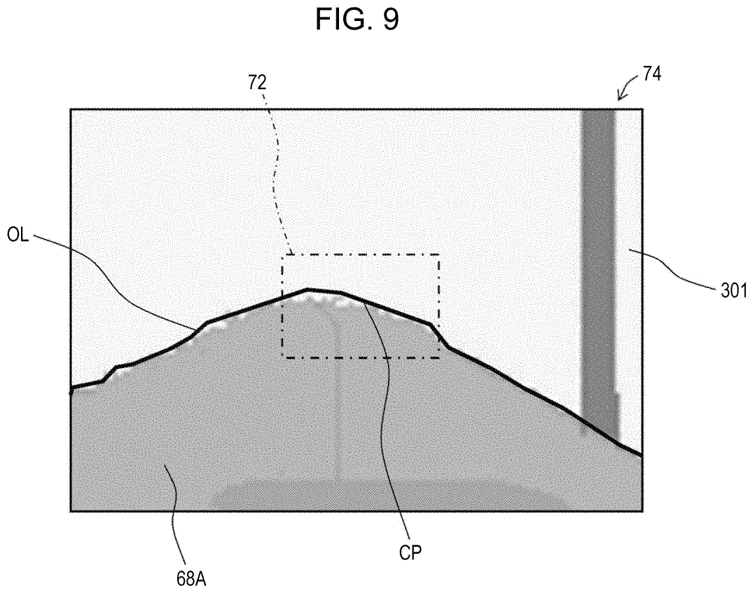

FIG. 9 is an illustration depicting the check region 301 displayed in an image display area 74 of the display 28. In FIG. 9, the center pixel CP of the image display area 74 corresponds to the outline pixel designated as the element No. 1. In this example, the outline OL of the cutout region 68A is displaced from the actual outline of the sofa at the center pixel CP and in the vicinity of the center pixel CP. Such “displacement” can precisely be checked by enlarging and displaying a portion of the mask image as depicted in FIG. 9 or by displaying the mask image without dropping any pixel.

In the above description, it is assumed that the outline pixel appears at the center of the image display area 74, but the outline pixel may appear slightly off the center of the image display area 74. In other words, the outline pixel is required to appear in a central region 72 of the image display area 74. For example, the central region 72 may be defined as a rectangular region (refer to FIG. 9) whose corners are located at a distance from the center of the image display area 74, where the distance is equal to 1/3 or less of the distance between the center and a corner of the image display area 74.

In a specific example of the check screen for the mask image, which will be described below, the image display area 74, in which the check region is displayed, is a part of the screen of the display 28, but the image display area 74 may match the entire screen of the display 28.

Next, the specific example of the check screen for the mask image 64 will be described. First, a description will be given of the mode in which the check region is moved based on the mouse wheel operation by the operator. FIG. 10 is the check screen for the mask image 64 in this mode. The check screen in FIG. 10 includes an entire-image display area 76, the image display area 74 (also referred to as a check-image display area 74), and a “Wheel” button 80. The entire-image display area 76 displays the whole of the mask image 64, and the image display area 74 displays the check region. The entire-image display area 76 displays the mask image 64 with the number of pixels reduced. The entire-image display area 76 includes a frame 78 that indicates the check region displayed in the image display area 74.

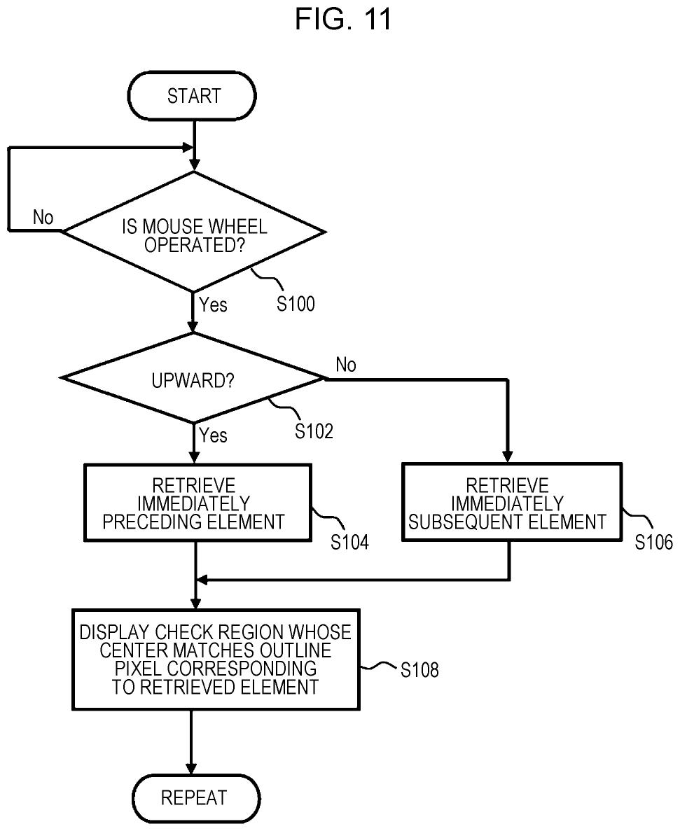

The operator operates a component such as a mouse and pushes the “Wheel” button 80. The push starts image display control based on the mouse wheel operation. FIG. 11 is a flowchart depicting a flow of the image display control based on the mouse wheel operation. First, in S100, the processor 12 checks whether the mouse wheel is operated and waits for the mouse wheel to be operated. If the mouse wheel is operated (Yes in S100), the processor 12 checks in S102 whether the mouse wheel is rotated upward or downward.

If the mouse wheel is rotated downward (No in S102), the processor 12 retrieves in S106 the outline coordinate pair of the immediately subsequent element in the piece of outline information 70. An element attracting interest at this moment in the piece of outline information 70 (hereinafter, referred to as an element of interest) is retained in memory by the repository 14. In S106, the processor 12 retrieves the outline coordinate pair of the element No. 2 if the element of interest is the element No. 1 in the piece of outline information 70. Then, in S108, the processor 12 displays in the image display area 74 the check region whose center matches the retrieved outline coordinate pair. At this time, the element number is increased by 1, and the element of interest is updated to the element No. 2. Then, the process returns to S100.

For example, if the operator repeats the downward rotation of the mouse wheel, the element number of the element of interest increases in succession. The check region accordingly moves along the outline OL of the cutout region 68A in counterclockwise direction, and the check regions are consecutively displayed in the image display area 74. This is the counterclockwise movement of the check region, which is described with reference to FIGS. 7 and 8. At the same time, the frame 78 displayed in the entire-image display area 76 in FIG. 10 also moves along the outline OL of the cutout region 68A in counterclockwise direction.

In contrast, if the mouse wheel is rotated upward in S102 in FIG. 11 (Yes in S102), the processor 12 retrieves in S104 the outline coordinate pair of the immediately preceding element in the piece of outline information 70. If the element of interest is the element No. 1, the processor 12 retrieves the outline coordinate pair of the element No. n (since no element has a smaller element number than 1, the outline coordinate pair of the element No. n is retrieved). Then, in S108, the processor 12 displays in the image display area 74 the check region whose center matches the retrieved outline coordinate pair. At this time, the element number is decreased by 1, and the element of interest is updated to the element No. n-1. Then, the process returns to S100.

For example, if the operator repeats the upward rotation of the mouse wheel, the element number of the element of interest decreases in succession. The check region accordingly moves along the outline OL of the cutout region 68A in clockwise direction, and the check regions are consecutively displayed in the image display area 74. This is the clockwise movement of the check region, which is described above. At the same time, the frame 78 displayed in the entire-image display area 76 in FIG. 10 also moves along the outline OL of the cutout region 68A in clockwise direction.

The flow in FIG. 11 may be designed to finish at the push of a predetermined button on the keyboard. Then, the mouse wheel can be used for usual operation of the PC.

In the example described above, since the operator can consecutively move a check region of a mask image by using a finger, the position of the outline of a cutout region can be checked in a very simple manner. The operator can perform check operation of the outline of a cutout region in a simpler manner than in the case where the operator operates vertical and horizontal scroll bars.

In the above description of the flow in FIG. 11, the immediately preceding element or the immediately subsequent element is retrieved in S104 or S106, but the element that precedes or follows the element of interest by two elements or more (for example, any number, such as 10, 100, or 1000, of elements) may be retrieved. In addition, when the element that precedes or follows the element of interest is retrieved in S104 or S106, the number of elements to skip (how far the element is separated forward or backward from the element of interest) may be determined so that the check region currently displayed in the image display area 74 does not overlap the check region to be displayed next in the image display area 74 after the mouse wheel is rotated.

In the example described above, the position of the check region is moved in accordance with the mouse wheel operation, but the position of the check region may be moved in accordance with the operation of a scroll bar 82 as depicted in FIG. 10. Specifically, instead of the downward rotation of the mouse wheel, operation of the scroll bar 82 by using a component such as a mouse to scroll from one end (first end) to the other end (second end) moves the check region along the outline OL of the cutout region 68A in counterclockwise direction. Further, instead of the upward rotation of the mouse wheel, operation of the scroll bar 82 by using a component such as a mouse to scroll from the second end to the first end moves the check region along the outline OL of the cutout region 68A in clockwise direction. In this configuration, a linear movement of a component such as a mouse can consecutively move the check region of a mask image.

Tools other than the mouse wheel or the scroll bar 82 may be used. The processor 12 may control display so that outline pixels that each correspond to a different outline coordinate pair consecutively appear in the central region 72 of the image display area 74 in accordance with continuous operation by the operator by using the mouse wheel, the scroll bar 82, or other tools. In this way, the check region that moves at a speed as intended by the operator is displayed in the image display area 74, and the position of the outline OL of the cutout region 68A can be checked at a speed as intended by the operator.

Next, a description will be given of a check screen for the mask image 64 in the mode in which the check region is automatically moved (also referred to as the automatic preview function). FIG. 12 is the check screen for the mask image 64 in this mode. The check screen in FIG. 12 includes the entire-image display area 76, the image display area 74 (check-image display area 74), a selector switch 98, and a plurality of buttons 90 to 96. The entire-image display area 76 displays the whole of the mask image 64, and the image display area 74 displays the check region. The entire-image display area 76 and the image display area 74 in FIG. 12 each have a configuration similar to the configuration of the counterpart in FIG. 10.

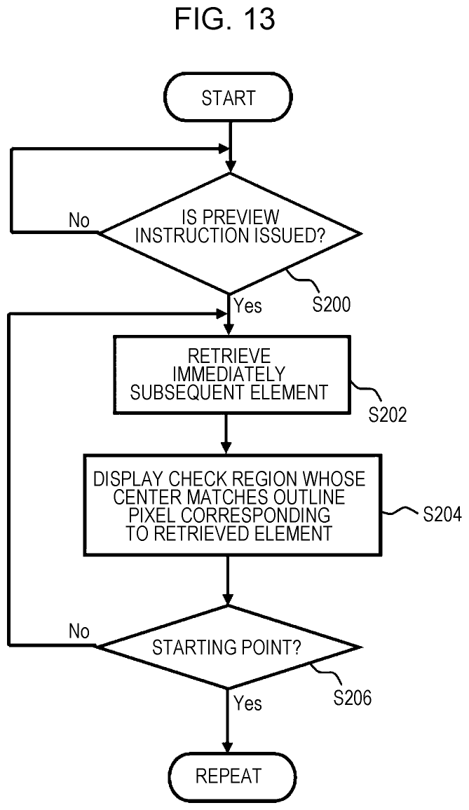

The operator operates a component such as a mouse and pushes the “Preview” button 90. The push starts image display control based on the automatic preview function. FIG. 13 is a flowchart depicting a flow of the image display control based on the automatic preview function. FIG. 13 depicts a flow corresponding to a case where the button “counterclockwise direction” of the selector switch 98 depicted in FIG. 12 is checked. First, in S200, the processor 12 checks whether the “Preview” button 90 is pushed and waits for the “Preview” button 90 to be pushed. The push of the “Preview” button 90 is also referred to as a preview instruction or a start instruction.

At the push of the “Preview” button 90 (Yes in S200), the processor 12 retrieves in S202 the outline coordinate pair of the immediately subsequent element in the piece of outline information 70. An element attracting interest at this moment in the piece of outline information 70 (element of interest) is retained in memory by the repository 14. In S202, the processor 12 retrieves the outline coordinate pair of the element No. 2 if the element of interest is the element No. 1. Then, in S204, the processor 12 displays in the image display area 74 the check region whose center matches the retrieved outline coordinate pair. At this time, the element number is increased by 1, and the element of interest is updated to the element No. 2.

In S206, the processor 12 checks whether the element of interest matches the element No. 1 (starting point). If a negative determination is made in S206, the process repeats S202 and S204. In other words, the element number is repeatedly increased by 1, and S202 and S204 are performed each time until the element of interest matches the element No. n and thereafter matches the element No. 1 (since no element has a larger element number than n, the element number returns to 1). The check region accordingly moves along the outline OL of the cutout region 68A in counterclockwise direction, and the check regions are consecutively displayed in the image display area 74. This is the counterclockwise movement of the check region, which is described with reference to FIGS. 7 and 8. At the same time, the frame 78 displayed in the entire-image display area 76 in FIG. 12 also moves along the outline OL of the cutout region 68A in counterclockwise direction.

Then, if an affirmative determination is made in S206 (the element of interest returns to the starting point), the movement of the check region is stopped. The process returns to S200, and the processor 12 waits for the “Preview” button 90 to be pushed again.

Next, a description will be given of image display control in a case where the button “clockwise direction” of the selector switch 98 depicted in FIG. 12 is checked and the “Preview” button 90 is pushed. This image display control is equivalent to the flow in FIG. 13 except that “retrieve the immediately subsequent element” in S202 is replaced by “retrieve the immediately preceding element”. Specifically, at the push of the “Preview” button 90 (Yes in S200), the processor 12 retrieves in S202 the outline coordinate pair of the immediately preceding element in the piece of outline information 70. In S202, if the element of interest is the element No. 1, the processor 12 retrieves the outline coordinate pair of the element No. n (since no element has a smaller element number than 1, the outline coordinate pair of the element No. n is retrieved). Then, in S204, the processor 12 displays in the image display area 74 the check region whose center matches the retrieved outline coordinate pair. At this time, the element number is decreased by 1, and the element of interest is updated to the element No. n-1. In S206, the processor 12 checks whether the element of interest matches the element No. 1 (starting point). If a negative determination is made in S206, the process repeats S202 and S204. In other words, the element number is repeatedly decreased by 1, and S202 and S204 are performed each time until the element of interest matches the element No. 1. The check region accordingly moves along the outline OL of the cutout region 68A in clockwise direction, and the check regions are consecutively displayed in the image display area 74. This is the clockwise movement of the check region, which is described above. At the same time, the frame 78 displayed in the entire-image display area 76 in FIG. 12 also moves along the outline OL of the cutout region 68A in clockwise direction.

In the example described above, at a single push of the “Preview” button 90, the check region moves around the closed loop of the outline OL of the cutout region 68A. Consequently, when the position of the outline OL (edge) of the cutout region 68A is checked, operation work can be reduced compared with a case where the operator operates a component such as a mouse all the time. In addition, similarly to the example of FIG. 10, the operator can perform check operation of the outline of a cutout region in a simpler manner than in the case where the operator operates vertical and horizontal scroll bars.

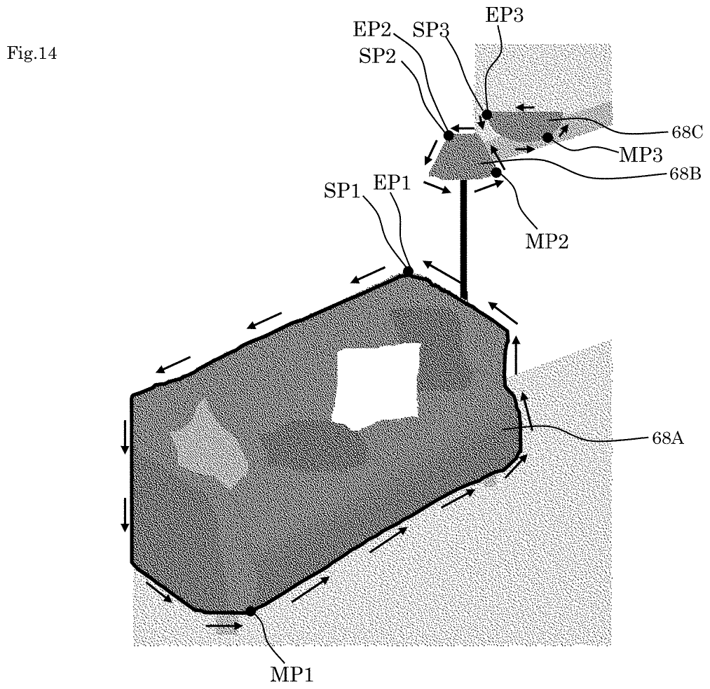

As depicted in FIG. 14, after moving around the closed loop of the outline of the cutout region 68A, the check region may jump to the outline of another cutout region, which is the cutout region 68B, and move around the closed loop of the outline of the cutout region 68B. In this way, at a single push of the “Preview” button 90, the check region may move between the outlines of the plurality of cutout regions 68A, 68B, and 68C.

Next, buttons other than the “Preview” button 90 depicted in FIG. 12, which are the buttons 91 to 96, will be described. The “Fast Forward” button 91 accelerates the movement of the check region. After the push of the “Preview” button 90, at the push of the “Fast Forward” button 91, the repetition from S202 to S206 in the flow in FIG. 13 is accelerated. Alternatively, in S202 in the flow in FIG. 13, “retrieve the immediately subsequent element” is replaced by “retrieve the element that follows the element of interest by two elements or more (for example, any number, such as 10, 100, or 1000, of elements)” (the number of elements to skip in the piece of outline information 70 is increased). Multiple pushes of the “Fast Forward” button 91 may further accelerate the movement of the check region. For example, at every push of the “Fast Forward” button 91, the number of elements to skip in S202 may be increased.

The “Fast Rewind” button 93 accelerates the movement of the check region in the direction opposite to the direction of the movement caused by the push of the “Fast Forward” button 91. Specifically, after the push of the “Preview” button 90, at the push of the “Fast Rewind” button 93, the check region moves at a high speed in the direction opposite to the direction set by the selector switch 98. The “Fast Rewind” button 93 has the same function as the “Fast Forward” button 91 except that the check region moves in the opposite direction.

The “Pause” button 96 causes the check region to temporarily stop moving. After the push of the “Preview” button 90, at the push of the “Pause” button 96, the element of interest described above is retained in memory by the repository 14, and the flow in FIG. 13 finishes. Subsequently, at the next push of the “Preview” button 90, the element of interest is retrieved from the repository 14, and the flow in FIG. 13 resumes. In this way, the check region can start moving again from where the check region is caused to stop moving at the push of the “Pause” button 96.

The “Stop” button 95 causes the check region to stop moving. After the push of the “Preview” button 90, at the push of the “Stop” button 95, the element of interest described above is reset to the element No. 1 and retained in memory by the repository 14, and the flow in FIG. 13 finishes. Subsequently, at the next push of the “Preview” button 90, the element of interest is retrieved from the repository 14, and the flow in FIG. 13 starts. Since the element of interest is the element No. 1 at this time, the check region starts moving from the initial position (starting point).

The “Skip” button 92 causes the check region to move to a predetermined position at once. As depicted in FIG. 6, the piece of outline information 70 may include one or more chapter points each of which is associated with an element. Examples of a chapter point include a starting point SP1 associated with the element No. 1, a middle point MP1 associated with the element No. m in the middle of the piece of outline information 70, and an end point EP1 associated with the element No. n. Such chapter points are desirably attached, for example, when the piece of outline information 70 is generated.

FIG. 14 depicts a mask image in which the positions of the outline pixels corresponding to SP1, MP1, and EP1 are indicated. After the push of the “Preview” button 90, at the push of the “Skip” button 92, the check region moves to MP1 at once. At the next push of the “Skip” button 92, the check region moves to EP1 at once. Chapter points may be attached to more elements.

As described above, the piece of outline information 70 is formed for each of the cutout regions 68A, 68B, and 68C. One or more chapter points are desirably included in the piece of outline information 70 for each of the cutout regions 68A, 68B, and 68C so that chapter points in a piece of outline information 70 are distinguishable from chapter points in other pieces of outline information 70. Chapter points SP2, MP2, and EP2 are attached to the cutout region 68B, and chapter points SP3, MP3, and EP3 are attached to the cutout region 68C. FIG. 14 depicts the outline pixels corresponding to these chapter points. In response to consecutive pushes of the “Skip” button 92, the check region may jump to MP1, EP1, SP2, MP2, EP2, SP3, . . . in this order, crossing the boundaries between the cutout regions 68A, 68B, and 68C.

The “Reverse Skip” button 94 depicted in FIG. 12 causes the check region to move to a chapter point at once in the direction opposite to the direction of the movement caused by the push of the “Skip” button 92. The “Reverse Skip” button 94 has the same function as the “Skip” button 92 except that the check region moves in the opposite direction.

The same functions as are provided by the “Skip” button 92 and the “Reverse Skip” button 94 in FIG. 12 may also be provided in the mode described above, in which the check region is moved based on the mouse wheel operation. For example, the left click on the mouse may activate the same function as is provided by the push of the “Skip” button 92, and the right click on the mouse may activate the same function as is provided by the push of the “Reverse Skip” button 94.

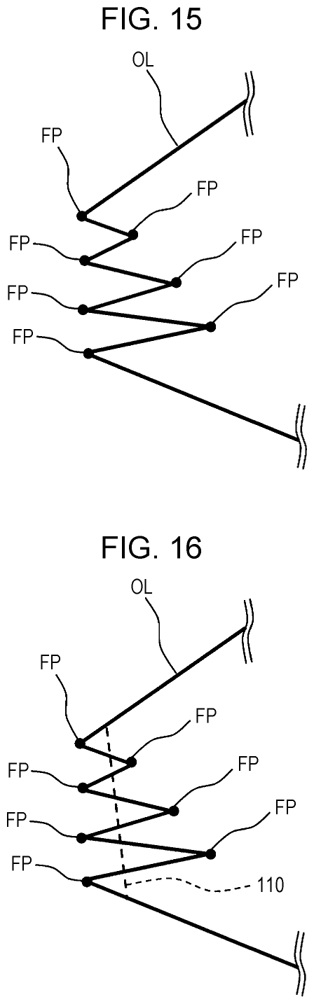

Next, a configuration applicable to each example described above will be described. As depicted in FIG. 15, the outline OL of a cutout region includes a portion having a simple geometrical shape and a portion having an intricate geometrical shape. The outline OL typically needs to be checked for “displacement” more closely in a portion having an intricate geometrical shape than in a portion having a simple geometrical shape. Accordingly, while moving the check region along the outline OL, the automatic preview function described above may decelerate the movement of the check region in a portion of the outline OL having an intricate geometrical shape compared with the movement in a portion having a simple geometrical shape. In FIG. 15, the check region moves more slowly along a zigzag line interposed between two straight lines of the outline OL above and below than along the two straight lines.

The above function can be realized, for example, as below. As depicted in FIG. 6, the piece of outline information 70 may include one or more flip points FP each of which is associated with an element. A flip point FP is associated with an element at which the variation in slope of the outline OL exceeds a predetermined criterion. The variation in slope of the outline OL can be obtained by calculating the second derivative of the outline OL. The one or more flip points FP are desirably attached, for example, when the piece of outline information 70 is generated. In the automatic preview function, the processor 12 controls display so as to change a speed in accordance with whether a flip point FP is attached to the element of interest (in accordance with the variation in slope of the outline OL of a cutout region), where the speed is defined as a rate at which outline pixels that each correspond to a different outline coordinate pair consecutively appear in the central region 72 of the image display area 74. Specifically, if a flip point FP is attached to the element of interest, the processor 12 controls display so as to decrease the speed at which outline pixels that each correspond to a different outline coordinate pair consecutively appear in the central region 72 of the image display area 74. In this way, the moving speed of the check region is varied in accordance with the geometrical shape of the outline OL described above.

In the above configuration, the processor 12 decelerate the movement of the check region if a flip point FP is attached to the element of interest, but the processor 12 may further enlarge and display the image of the check region if a flip point FP is attached to the element of interest. Specifically, a portion of the outline OL having an intricate geometrical shape is displayed in an enlarged form that contains not only the pixels forming the image of the check region but also interpolating pixels based on the pixels forming the image of the check region. In this way, the operator can more precisely check the portion of the outline OL having an intricate geometrical shape.

In addition, as depicted in FIG. 15, while the check region moves along a zigzag line of the outline OL, the check region moves wobbling horizontally and vertically. Thus, displacement of the outline OL may be difficult to check in the check region displayed in the image display area 74. Thus, as depicted in FIG. 16, in a region where one or more elements to which a flip point FP is attached are present, an approximate function (approximate line 110) may be presumed, and the check region may be moved along the approximate line 110. In this way, smoothly changing and easily discernible display can be achieved. This configuration may be applied to both the mode in which the check region is moved based on the mouse wheel operation (FIG. 10) and the mode based on the automatic preview function (FIG. 12).

Further, instead of presuming an approximate function, in a region where one or more elements to which a flip point FP is attached are present, the process in which the immediately preceding element or the immediately subsequent element is retrieved in S104 or S106 in the flow in FIG. 11 may be replaced by a process in which the element that precedes or follows the element of interest by a large number of elements (for example, any number, such as 10, 100, or 1000, of elements) is retrieved. Similarly, in a region where one or more elements to which a flip point FP is attached are present, the process in which the immediately subsequent element is retrieved in S202 in the flow in FIG. 13 may be replaced by a process in which the element that follows the element of interest by a large number of elements (for example, any number, such as 10, 100, or 1000, of elements) is retrieved. In this configuration, the horizontal and vertical wobble of the check region is also suppressed or reduced, and smoothly changing and easily discernible display can be achieved.

In the embodiment above, the processor operates in accordance with a program but may be in a different form. The term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire an original image and a plurality of outline coordinate pairs of an outline of a region to be cut out from the original image, and
control display in an image display area to superimpose an image of the outline onto a portion of the original image so that pixels that correspond to the plurality of outline coordinate pairs consecutively appear in a central region of the image display area in clockwise or counterclockwise order.

2. The information processing apparatus according to claim 1,
wherein the processor controls the display so that pixels that each correspond to a different outline coordinate pair of the plurality of outline coordinate pairs consecutively appear in the central region of the image display area in accordance with continuous operation by an operator.

3. The information processing apparatus according to claim 1,
wherein the processor controls the display so that pixels that each correspond to a different outline coordinate pair of the plurality of outline coordinate pairs consecutively appear in the central region of the image display area automatically in response to a reception of a starting instruction by an operator.

4. The information processing apparatus according to claim 2,
wherein the processor controls the display so that pixels that each correspond to a different outline coordinate pair of the plurality of outline coordinate pairs consecutively appear in the central region of the image display area in accordance with operation of a mouse wheel by an operator.

5. The information processing apparatus according to claim 2,
wherein the processor controls the display so that pixels that each correspond to a different outline coordinate pair of the plurality of outline coordinate pairs consecutively appear in the central region of the image display area in accordance with operation of a scroll bar by an operator, the scroll bar being displayed on a display screen of an image display device.

6. The information processing apparatus according to claim 3,
wherein the processor controls the display so as to change a speed in accordance with variation in slope of the outline of the region to be cut out, the speed being defined as a rate at which pixels that each correspond to a different outline coordinate pair of the plurality of outline coordinate pairs consecutively appear in the central region of the image display area.

7. The information processing apparatus according to claim 1,
wherein an image displayed in the image display area includes an image that represents a portion of the original image pixel by pixel or an image that enlarges a portion of the original image.

8. The information processing apparatus according to claim 2,
wherein an image displayed in the image display area includes an image that represents a portion of the original image pixel by pixel or an image that enlarges a portion of the original image.

9. The information processing apparatus according to claim 3,
wherein an image displayed in the image display area includes an image that represents a portion of the original image pixel by pixel or an image that enlarges a portion of the original image.

10. The information processing apparatus according to claim 4,
wherein an image displayed in the image display area includes an image that represents a portion of the original image pixel by pixel or an image that enlarges a portion of the original image.

11. The information processing apparatus according to claim 5,
wherein an image displayed in the image display area includes an image that represents a portion of the original image pixel by pixel or an image that enlarges a portion of the original image.

12. The information processing apparatus according to claim 6,
wherein an image displayed in the image display area includes an image that represents a portion of the original image pixel by pixel or an image that enlarges a portion of the original image.

13. A non-transitory computer readable medium storing a program causing a computer to execute a process for information processing, the process comprising:
acquiring an original image and a plurality of outline coordinate pairs of an outline of a region to be cut out from the original image; and
controlling display in an image display area to superimpose an image of the outline onto a portion of the original image so that pixels that correspond to the plurality of outline coordinate pairs consecutively appear in a central region of the image display area in clockwise or counterclockwise order.

14. An information processing apparatus comprising:
processing means for:
acquiring an original image and a plurality of outline coordinate pairs of an outline of a region to be cut out from the original image; and
controlling display in an image display area to superimpose an image of the outline onto a portion of the original image so that pixels that correspond to the plurality of outline coordinate pairs consecutively appear in a central region of the image display area in clockwise or counterclockwise order.
